(19) United States
(12) Patent Application Publication
(10) Pub. No.: US 2009/0147516 A1
(43) Pub. Date: Jun. 11, 2009

(54) SOLID ILLUMINATION DEVICE

(75) Inventors: CHUN-WEI WANG, Chu-Nan (TW); HUNG-KUANG HSU, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/016,144

(22) Filed: Jan. 17, 2008

(30) Foreign Application Priority Data
Dec. 7, 2007 (CN) 200710202940.9

(51) Int. Cl. F21V 7/00

(52) U.S. Cl. 362/247

(57) ABSTRACT

A solid illumination device includes a light emitting module (30), a heat sink (20), a plurality of supporters (25) and a plurality of optical protrusions (40). The light emitting module includes a plurality of printed circuit broads (34) and a plurality of point light sources (32) electrically connected to each of the printed circuit broads. The heat sink includes a substrate (21) which has a supporting surface (210). The supporter has slanted side faces (250b, 250c). An acute angle θ is formed between each of the side faces and a normal line F of the supporting surface. The optical protrusions are located on the supporting surface of the substrate. The point light sources are located on the side faces and a portion of light emitted from the point light sources is irradiated downwardly towards the supporting surface and reflected by the optical protrusions.

### BACKGROUND

1. Technical Field

The present invention relates generally to solid illumination devices, and more particularly to an LED (light emitting diode) illumination device.

2. Description of Related Art

Non-emissive display devices such as LCD (Liquid Crystal Display) panels, floor mats, or logo display boards are commonly used in daily life. External light sources are applied in the display devices for providing illuminations for the non-emissive display devices. LEDs (light emitting diode) are preferred to be used in the non-emissive display devices instead of CCFLs (cold cathode fluorescent lamp) due to their high brightness, long life-span, and wide color gamut. This is disclosed in an article on Proceedings of the IEEE, Vol. 93, No. 10, entitled “Solid-State Lighting: Toward Superior Illumination”, authored by Michael S. Shur in October, 2005, the disclosure of which is incorporated herein by reference.

Referring to FIG. 5, a typical LED illumination device 10 includes a light emitting module 11 and a diffuser plate 16. The light emitting module 11 includes a printed circuit broad 14 and a plurality of LEDs 12 electrically connected to the printed circuit broad 14. It is known that the majority of lights emitted from LED chips travels in a direction approximately perpendicular to the chip surface. Therefore, the majority of the lights emitted from the plurality of LEDs 12 travels in a direction approximately perpendicular to a bottom surface of the diffuser plate 16, which induces a peripheral portion of the diffuser plate 16 to be darker than a central portion thereof. This causes the light to non-uniformly distribute over the display devices. Therefore, the LEDs need to be arranged in a way such that the lights emitted from different LED chips have a chance to be combined and mixed in order to achieve desired chromaticity before they reach a display screen, and also there is a need for improving the display efficiency of the display devices.

### SUMMARY

The present invention relates to a solid illumination device. According to a preferred embodiment of the present invention, the solid illumination device includes a light emitting module, a heat sink, at least a supporter and at least an optical protrusion. The light emitting module includes a plurality of printed circuit broads and a plurality of point light sources electrically connected to each of the printed circuit broads. The heat sink includes a substrate which has a supporting surface. The supporters are provided on the substrate. The supporters are supporting the printed circuit boards thereon, each of the supporters has a slanted side face relative to the supporting surface of the substrate. An acute angle is formed between the slanted side face and a normal line to the supporting surface of the substrate. The optical protrusions are provided on the supporting surface of the substrate for reflecting light incident thereon. The point light sources are located on the slanted side faces of the supporters being configured for emitting light towards the optical protrusions.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1a schematic, isometric view of an solid illumination device according to a first present embodiment;

FIG. 2 is a schematic, cross sectional view of the solid illumination device of FIG. 1, taken along line II-II thereof;

FIG. 3 is a schematic, isometric view of a solid illumination device according to a second present embodiment;

FIG. 4 is a schematic, cross sectional view of the solid illumination device of FIG. 3, taken along line IV-IV thereof; and

FIG. 5 a schematic, cross-sectional view of a light emitting diode illumination device in accordance with related art.

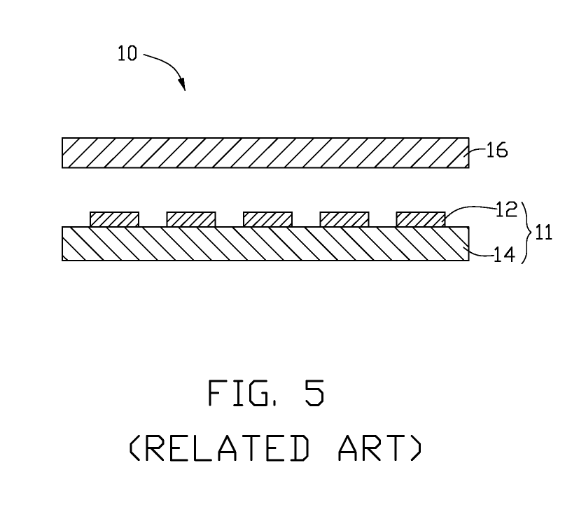

### DETAILED DESCRIPTION OF THE INVENTION

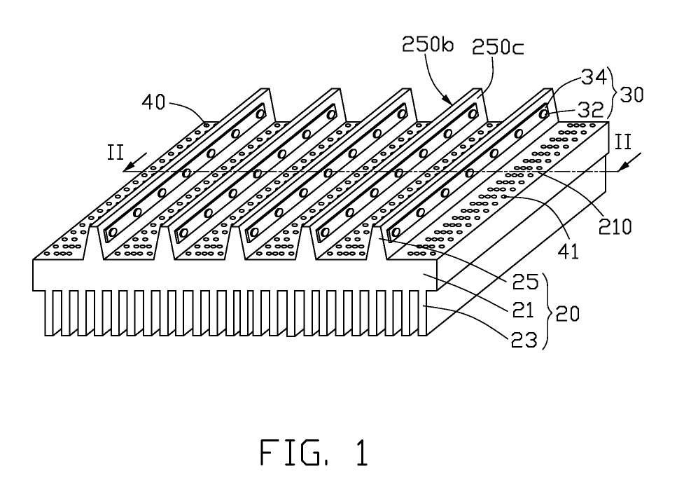

Reference will now be made to the drawing figures to describe the various present embodiments in detail. Referring to FIG. 1, a solid illumination device according to a first present embodiment is provided. The solid illumination device includes a heat sink 20, a light emitting module 30 and a plurality of optical protrusions 40.

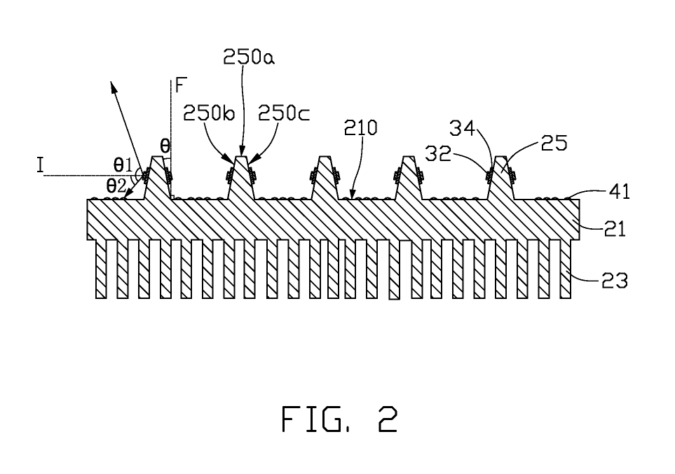

The heat sink 20 can be made of a highly thermally conductive material, such as aluminum, copper and their alloys. The heat sink 20 includes a substrate 21, a plurality of heat dissipation fins 23 and a plurality of supporters 25. The substrate 21 is planner-shaped, having a top surface and an opposite bottom surface. The heat dissipation fins 23 are extended downwardly and perpendicularly from the bottom surface of the substrate 21. The supporters 25 are extended upwardly from the top surface of the substrate 21. The supporters 25 are paralleled and spaced to each other, and each of the supporters 25 is arranged along a longitudinal direction of the substrate 21 of the heat sink 20. A plurality of rectangular supporting surfaces 210 for supporting the optical protrusions 40 are partitioned off from the top surface of the substrate 21 by the supporters 25, thus to form a plurality of optical surfaces to reflect and combine lights which are emitted from the light emitting module 30. The supporters 25, the fins 23 and the substrate 21 of the heat sink 20 are integrally formed by injection molding process or aluminum extrusion process as a single piece. Alternatively, the supporters 25 and the substrate 21 of the heat sink 20 can be molded separately and then be affixed to each other. Each of the supporters 25 includes a top face 250a paralleled to the supporting surfaces 210 of the substrate 21, and a left slanted side face 250b and a right slanted side face 250c interconnected between the top face 250a of the supporter 25 and the supporting surfaces 210 of the substrate 21, such that a cross-sectional view of each of the supporters 25 is in a trapezoidal profile. Referring to FIG. 2, an acute angle θ is formed between the left or the right slanted side face 250b, 250c of the supporter 25 and a normal line F of the supporting surface 210 of the substrate 21. Alternatively, the shape of the supporters 25 can be varied, but it is needed to ensure that each of the supporters 25 has at least one slanted side face which is inclined with respect to the supporting surface 210 of the substrate 21.

The light emitting module 30 includes a plurality of printed circuit broads 34 and a plurality of point light sources 32 electrically connected to the plurality of printed circuit broads 34 respectively. In this embodiment, the point light sources 32 in the light emitting module 30 are a plurality of light emitting diodes (LEDs). Each of the printed circuit broads 32 is attached to the left slanted side face 250b or the right slanted side face 250c of the supporter 25. The printed circuit broads 32 and the supporters 25 are insulated to each other. The printed circuit broads 34 can be metal core printed circuit boards, flexible printed circuit broads, ceramic substrate printed circuit boards and so on.

The optical protrusions 40 are a plurality of optical protruding dots 41 which are distributed on the supporting surfaces 210 of the substrate 21 compactly. The optical protruding dots 41 are made of materials including ceramic, fluorescent powder, metal, white ink, etc, and are formed on the supporting surfaces 210 of the substrate 21 by ink jetting or printing. A distributing area of the optical protruding dots 41 and a distributing compactness of the optical protruding dots 41 within the distributed area are determined according a magnitude of a radiation angle of the point light source 32, and a magnitude of the acute angles θ formed between the left or right slanted side face 250b, 250c of the supporters 25 and the normal line F of the supporting surface 210 of the substrate 21. More specifically, it is needed to ensure that the distributing area of the optical protruding dots 41 is large enough, such that the light emitted from the point light source 32 can incident on and be reflected by the optical protruding dots 41 distributed on the distributed area. Moreover, the distributing compactness of the optical protruding dots 41 on a middle portion of the distributed area is preferably larger than the distributing compactness on the other portion of the distributed area, such that the majority of light emitted from the point light source 32 downwardly towards the supporting surface 210 of the substrate 21 can incident on and be effectively reflected by the optical protruding dots 41. As a result, the light emitted from the point light source 32 downwardly towards the supporting surface 210 can be reflected and combined through the optical protruding dots 41 on the supporting surfaces 210 of the substrate 21, to achieve a high light intensity and a good uniformity.

For the left and the right slanted side faces 250b, 250c of the supporters 25 are both inclined with the acute angle θ formed relative to the normal line F of the supporting surface 210 of the substrate 21, the point light sources 32 located on the left and the right slanted side faces 250b, 250c of the supporters 25 are inclined relative to the supporting surface 210 of the substrate 20 as well. For benefit of description and understanding, it is assumed that the acute angle θ formed between each of the slanted side faces 250b, 250c of the supporters 25 and the normal line F of the supporting surface 210 of the substrate 21 is 5°, and the radiation angle θ1 of each of the point light sources 32 is 120°. Therefore, an angle θ2 of 55° is formed between a horizontal reference line I and a lowest portion of the light emitted from the point light source 32, the portion of the light within the angle θ2 are irradiated downwardly towards the supporting surface 210 of the substrate 21.

The acute angle θ formed between each of the slanted side faces 250b, 250c of the supporter 25 and the normal line F of the supporting surface 210 of the substrate 21 can be varied according to the magnitude of the radiation angle θ1 of each of the point light source 32, and according to the magnitude of the distributing area and the distributing compactness of the optical protruding dots 41 on the supporting surface 210 of the substrate 21. In one aspect, the point light sources 32 are needed to be arranged in such a way that at least a portion of light emitted from the point light sources 32 can radiate downwardly towards the supporting surface 210 of the substrate 21. In another aspect, it is needed to ensure that the portion of the light irradiated downwardly towards the supporting surface 210 of the substrate 21 can irradiate on and be effectively by the optical protruding dots 41. Therefore, the lights emitted from the point light sources 32 have a chance to be combined and mixed so as to achieve high light intensity and good uniformity. Preferably, the acute angle θ formed between each of the slanted side faces 250b, 250c of the supporter 25 and the normal line F of the supporting surface 210 of the substrate 21 is in the range from 5° to 85°, such that the portion of light irradiated downwardly towards the supporting surface 210 of the substrate 21 only occupies a comparatively small portion among all of the light emitted from the point light source 32, and the portion of light irradiated downwardly towards the supporting surface 210 of the substrate 21 can be effectively reflected by the optical protruding dots on the supporting surfaces 210 of the substrate 21, thereby achieving a higher light intensity and a better uniformity.

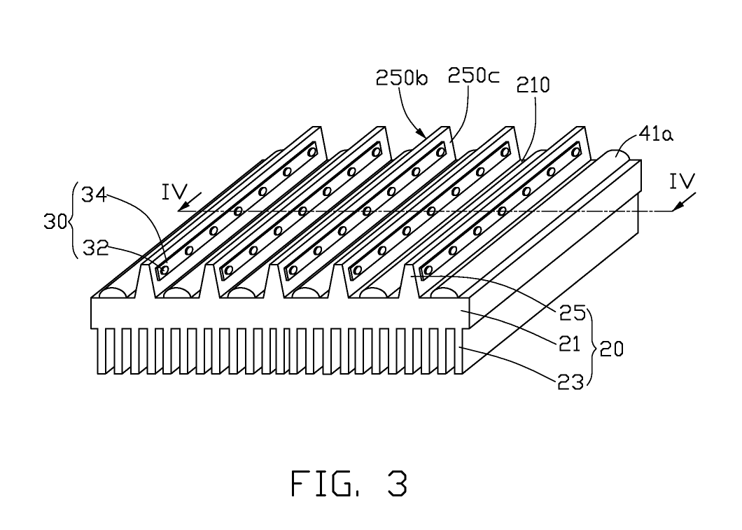

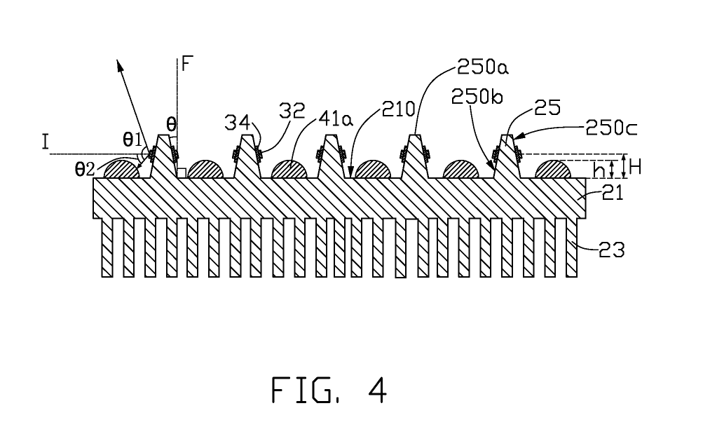

FIG. 3 and FIG. 4 show a second embodiment of the solid illumination device. Except for the optical protrusions, other parts of the solid illumination device in accordance with this second embodiment have substantially the same configurations as the solid illumination device of the previous first embodiment. More specifically, the optical protrusions in this second embodiment include a plurality of elongated optical protruding strips 41a located on the plurality of supporting surfaces 210 of the substrate 21 respectively. The elongated optical protruding strips 41a are made of light dispersible material, including silica gel impregnated with ceramic power, silica gel impregnated with fluorescent powder, white plastic, metal and etc. Each of the elongated optical protruding strips 41a is long and narrow in shape, has a continuous outside surface along its extending direction, and locates on a corresponding supporting surface 210 between corresponding two neighboring supporters 25. According to desired applications, the elongated optical protruding strips 41a can be formed in any suitable manner and shape and made of any suitable material. A cross-sectional shape of the elongated optical protruding strip 41a can be, but not limited to, pyramidal, conic, parabolic or semispherical. A height h of the highest point of the elongated optical protruding strip 41a is not larger than a locating height H of the point light source 32 located on the left or right slanted side face 250b, 250c with respect to the supporting surface 210 of the substrate 21. The function of the elongated optical protruding strips 41a is similar to that of the optical protruding dots 41 explicitly mentioned in the preceding discourse. More specifically, the continuous outside surface of each of the elongated optical protruding strips 41a is formed as the optical surface. The light emitted from the point light source 32 downwardly towards the supporting surface 210 of the substrate 21 is reflected by the optical surface (i.e., the outside surface of the elongated optical protruding strip) to irradiate upwardly towards different directions. Thus, the lights emitted from different point light sources have a chance to be combined and mixed in order to achieve a desired chromaticity.

The elongated optical protruding strips 41a and the substrate 21 of the heat sink 20 can be molded separately and then be affixed to each other. Alternatively, the elongated optical protruding strips 41a and the heat sink 20 can be directly integrally formed as a single piece by injection molding, or aluminum extrusion process. In this embodiment, the elongated optical protruding strips 41a are simple in structure and easy to make, and the continuous outside surface of each of the elongated optical protruding strips 41a can maximize the reflective surface area for the portion of light emitted from the point light sources 32 downwardly towards the supporting surface 210 of the substrate 21.

It is to be understood, however, that even though numerous characteristics and advantages of the present invention have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A solid illumination device comprising:
a light emitting module comprising a plurality of printed circuit broads and a plurality of point light sources electrically connected to each of the printed circuit broads;
a heat sink comprising a substrate which has a supporting surface;
a plurality of supporters provided on the substrate, the supporters supporting the printed circuit boards thereon, each of the supporter having a slanted side face relative to the supporting surface of the substrate, an acute angle formed between the slanted side face and a normal line to the supporting surface of the substrate; and
a plurality of optical protrusions provided on the supporting surface of the substrate for reflecting light incident thereon, the point light sources located on the slanted side faces of the supporters being configured for emitting light towards the optical protrusions.

2. The solid illumination device of claim 1, wherein the plurality of point light sources include a plurality of light emitting diodes.

3. The solid illumination device of claim 1, wherein the acute angle is in the range from 5° to 85°.

4. The solid illumination device of claim 1, wherein the supporters are spaced from each other, the optical protrusions includes a plurality of optical dots distributed between every two neighboring supporters.

5. The solid illumination device of claim 1, wherein the optical protrusions include a plurality of elongated optical protruding strips arranged on the supporting surface of the substrate, and each of the elongated optical protruding strips has a continuous outside surface along a lengthwise direction thereof.

6. The solid illumination device of claim 5, wherein the supporters and the elongated optical protruding strips are alternately arranged on the supporting surface of the substrate.

7. The solid illumination device of claim 1, wherein the heat sink further comprises a plurality of heat dissipation fins extending from the substrate in a direction away from the supporting surface of the substrate.

8. The solid illumination device of claim 1, wherein the supporters and the substrate of the heat sink are integrally formed.

9. The solid illumination device of claim 1, wherein the supporters and the substrate of the heat sink are formed separately and then be affixed to each other.

10. A solid illumination device comprising:
a heat sink including a substrate, a plurality of supporters extending upwardly from the substrate and a plurality of fins extending downwardly from the substrate, each of the supporters having a slanted side face relative to the substrate;
at least a light source supported on the slanted side face for emitting light towards the substrate; and
a plurality of optical protrusions provided on the substrate and between every two adjacent supporters, the optical protrusions being configured for reflecting the light emitted from the at least a light source.

11. The solid illumination device of claim 10, wherein the optical protrusions include a plurality of elongated optical protruding strips arranged along the substrate.

12. A solid illumination device comprising:
a heat sink including a substrate, a plurality of parallel spaced elongated protruding supporters formed on a first surface of the substrate and a plurality of fins formed on an opposite second surface of the substrate, each of the supporters having opposite side faces slanted relative to the first surface of the substrate;
a plurality of light emitting diodes mounted on the side faces of each of the supporters for emitting light towards the first surface of the substrate; and
a plurality of optical reflective protrusions provided on the first surface of the substrate and arranged between every two adjacent supporters, the optical reflective protrusions being configured for reflecting the light emitted from the light emitting diodes.
